(19) United States
(12) Patent Application Publication
(10) Pub. No.: US 2009/0276476 A1
(43) Pub. Date: Nov. 5, 2009

(54) PEER-TO-PEER DATA ARCHIVING AND RETRIEVAL SYSTEM

(76) Inventor: Chris Jolly, Ramsgate (GB)

Correspondence Address: IGOE INTELLECTUAL PROPERTY, LLC, 1628 JFK Blvd Suite 1975, PHILADELPHIA, PA, 19103, US

(21) Appl. No.: 12/435,390

(22) Filed: May 4, 2009

Related U.S. Application Data
(60) Provisional application No. 61/050,448, filed on May 5, 2008.

(51) Int. Cl. G06F 17/30

(52) U.S. Cl. 707/204; 707/100; 707/E17.01; 707/E17.044

(57) ABSTRACT

A peer-to-peer system for the archiving and retrieval of data, and associated methods, are provided. One associated method comprises the steps of, at an archive server: receiving a data record over a network from a data generating system, assigning the data record to a storage segment, calculating a signature for data comprising the received data record, storing the calculated signature and an indication of the assigned data segment in a data structure associated with an archive data store, and storing data comprising the received data record in the archive data store. Data comprising received records may also be encrypted and compressed. Data may be provided to other archive data stores to provide greater robustness and the ability to recover from disasters.

This application claims the benefit of U.S. Provisional Application No. 61/050,448, filed May 5, 2008.

### TECHNICAL FIELD OF THE INVENTION

The technical field relates generally to the archive and management of data.

### BACKGROUND

The amount of electronic content produced by companies has increased rapidly in recent years. The resulting demands placed upon corporate networks, infrastructures and e-mail servers continue to grow, burdening IT staff and impacting user productivity. Maintaining the electronic content may be overwhelming, as it must be captured, indexed, stored, retained, retrieved, secure and eventually deleted after a statutorily defined retention period. Failure to adequately deal with electronic content may expose companies to legal or regulatory liability.

A need exists for a data management system which acquires, stores, manages, and provides access to electronic content in such a way that the burden on IT staff is reduced, the content is robustly protected, and legal and regulatory needs are met.

### SUMMARY OF THE INVENTION

The present invention comprises a system and associated methods for the archive and retrieval of data. In one embodiment, the present invention comprises a method comprising the steps of, at an archive server: receiving a data record over a network from a data generating system, assigning the data record to a storage segment, calculating a signature for data comprising the received data record, storing the calculated signature and an indication of the assigned storage segment in a data structure associated with an archive data store, and storing data comprising the record in the archive data store.

In another embodiment, the invention relates to receiving a data record over a network from a data generating system, assigning the data record to a storage segment, calculating a signature for data comprising the received data record, storing the calculated signature and an indication of the assigned storage segment in a data structure associated with an archive data store, and storing data comprising the record in the archive data store.

A system according to the invention may comprise means for receiving a data record over a network from a data generating system, means for assigning the data record to a storage segment, means for calculating a signature for data comprising the received data record, means for storing the calculated signature and an indication of the assigned storage segment in a data structure associated with an archive data store, and means for storing data comprising the record in the archive data store.

In some embodiments, the data generating system comprises an email server. In some embodiments, the data structure associated with the archive data store comprises an S-tree. In some embodiments, the archive data store comprises a persistent heap. In some embodiments, the archive data store comprises a relational database. In some embodiments, the method further comprises the step of encrypting the data record. In some embodiments, the method further comprises the step of compressing the data record. In some embodiments, the signature comprises a checksum.

In still other embodiments, the method, or processing by a system, may further comprise the steps of, responsive to a determination that a specified period of time has passed, automatically deleting the stored received data and removing the calculated signature and the indication of the assigned data segment from the data structure associated with the archive data store. In other embodiments, the method or processing may further comprise the steps of storing an additional entry in the data structure associated with the archive data store and storing a redundant copy of the data in the data archive. In still another embodiment, the method further comprises the steps of altering the stored data and conveying information regarding the altering to a second archive server. In still another embodiment, the method further comprises the steps of contacting an agent module of another archive server and providing the received data for storage in a second archive data store associated with a second archive server.

### BRIEF DESCRIPTION OF THE DRAWINGS

The foregoing summary, as well as the following detailed description, is better understood when read in conjunction with the attached drawings. For the purpose of illustrating data archive and retrieval system, there is shown in the drawings exemplary constructions thereof; however, the data archive and retrieval system is not limited to the specific methods and instrumentalities disclosed.

FIG. 1 is an example environment 100 for the archiving of data.

FIG. 2 is a flow diagram of an example process 200 for scheduling a task.

FIG. 3 is a flow diagram of an example process 300 for scheduling a continuous task.

FIG. 4 is a flow diagram of an example process 400 for synchronizing an insert record operation to a local database with one or more remote databases.

FIG. 5 is a flow diagram of an example process 500 for synchronizing an update record operation to a local database with one or more remote databases.

FIG. 6 is a flow diagram of an example process 600 for synchronizing a delete operation to a local database with one or more remote databases.

FIG. 7 is a flow diagram of an example process 700 for synchronizing a local copy of a data base with one or more remote databases.

FIG. 8 is a block diagram of an example computer system 800 that can be utilized to implement the systems and methods described herein.

Like reference numbers and designations in the various drawings indicate like elements.

### DETAILED DESCRIPTION OF THE PREFERRED EMBODIMENTS

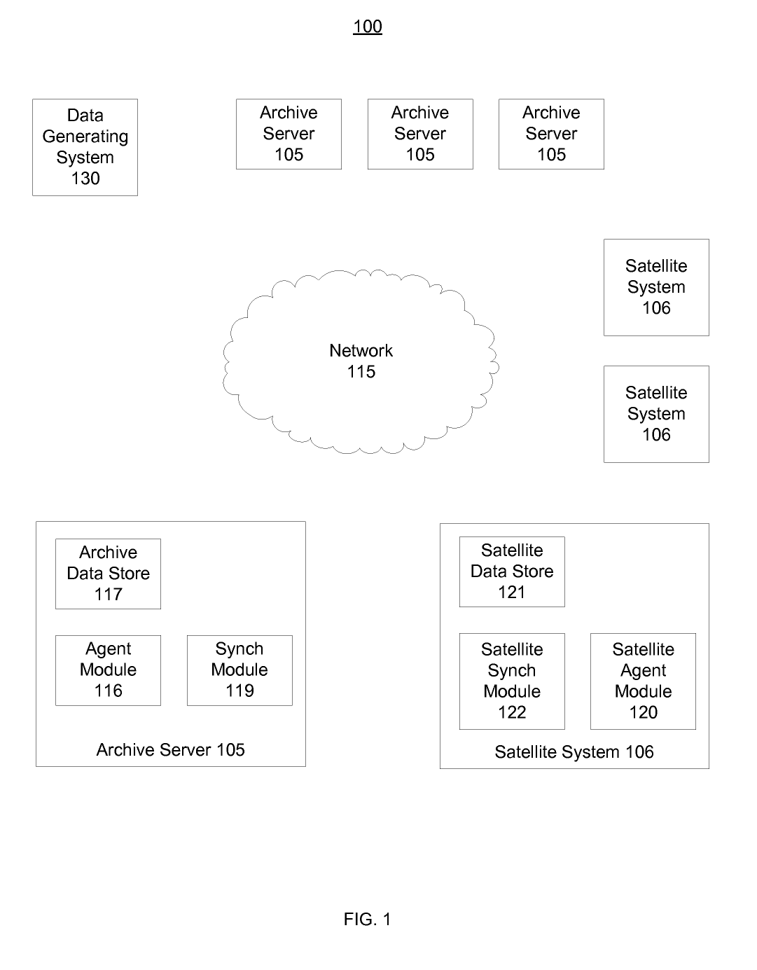

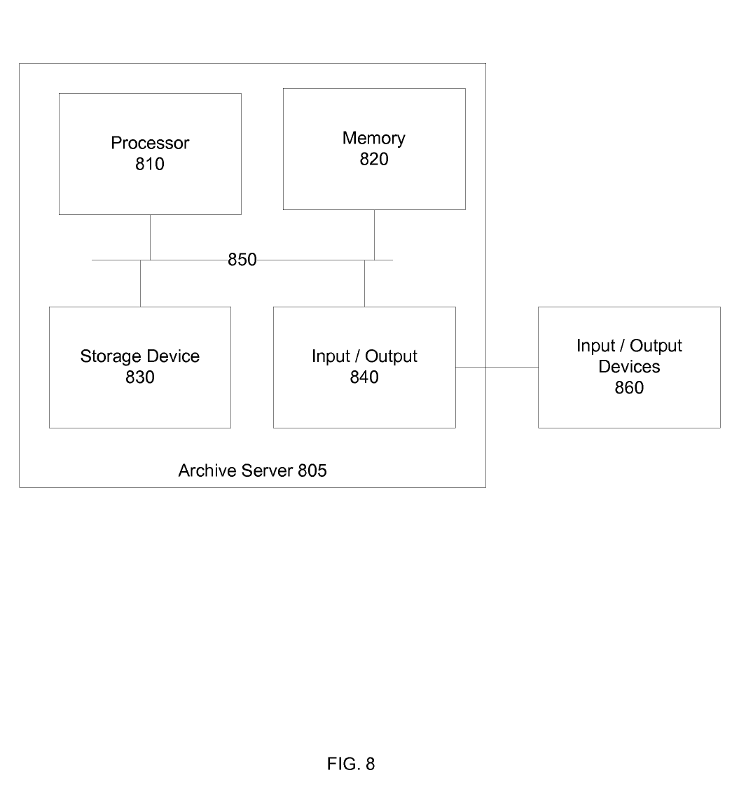

FIG. 1 is an example environment 100 for the archiving and providing of data. In some implementations, the environment 100 may include one or more archive servers 105. The archive servers 105 may be implemented using a computer system such as the system 800 described with respect to FIG. 8, for example.

The archive servers 105 may communicate with one another over a network 115. The network 115 may include a variety of public and private networks such as a public-switched telephone network, a cellular telephone network, and/or the Internet, for example.

In some implementations, the archive servers 105 may include agent modules 116. The agent modules 116 may communicate with other agent modules 116 executing at archive servers 105 without using a centralized server. For example, the agent modules 116 may communicate with each other using peer-to-peer (P2P), or grid networking techniques. While only one agent module 116 is shown implemented in an archive server 105, this is for illustrative purposes only, each archive server 105 may implement several agent modules 116.

In some implementations, the agent modules 116 may discover or identify other agent modules 116 on the network 115. The agent modules 116 may periodically identify all agent modules 116 on the network 115, or may ask that agent modules 116 on the network 115 identify themselves. The agent modules 116 may identify other agent modules 116 on the network 115 using a variety of methods including JXTA, for example. However, other implementations are feasible.

The archive servers 105 may further include one or more archive data stores 117. The archive data stores 117 may store a variety of archived data including e-mail data, document management system data, VOIP data, voice-mail data, and any other type of data that may be produced during the operations of a business or company, for example. In some implementations, the archive data store 117 may be implemented as a relational database. In other implementations, the archive data store 117 may be implemented as a flat text file, for example.

In still other implementations the archive data store 117 may be implemented in a persistent heap format. The use of a persistent heap format offers the advantage of other archive formats in combining many smaller files that would otherwise be unwieldy to move and access with the ability to efficiently update the archived files. A persistent heap implementation may allow deletion of an archived file such that the space it occupied can be reused by a new file added to the archive, appending to an existing archived file, adding a new file to the archive at any point in the archive's lifecycle, extracting archived files without the need for a directory structure, and reading archived files without the need to read sequentially from the start of the archive to locate them. Deletion may be secure. The previous contents of the file can be overwritten by a fixed bit pattern so that the deleted file cannot be reconstructed.

Persistent Heap files may consist of blocks, which may be of a fixed size. In some embodiments, since the minimum size that a file in the archive can occupy is one block, the block size should be chosen with care. For example, a block size of 16,384 bytes may be utilized. However, a variety of block sizes may be used depending on the type of data that is being stored in the heap.

The Persistent Heap may contain a Header Block. In some embodiments, block zero, the first block in the file, starting at byte offset zero, may be the Header Block and may contain the following information: “freeHead,” a 64-bit integer indicating the byte offset of the first block in the free list (initially zero), “freeTail,” a 64-bit integer indicating the byte offset of the last block in the free list (initially zero), and “fileCount,” a 32-bit integer indicating the number of files in the archive (initially zero).

The Persistent Heap may also comprise a Free List. The Free List may comprise a linked list of allocated, but unused, blocks. An indication that a block is allocated may mean that the block is inside the extent of the archive file, but not part of any archived file. In some implementations, each block on the Free List contains just the 64-bit byte offset of the next block in the Free List or zero if it is the last block in the free list.

Files contained in the archive may comprise a header block containing header information of the file, the first block of file data, and, if required, subsequent data blocks containing a link to the next allocated block plus file data up to the block size.

In a preferred embodiment, the File Header Block may comprise fields comprising: “nextBlock,” a 64-bit integer indicating the byte offset of the next block in the file (a file data block) or zero if there are no additional data blocks, “magic,” a 64-bit integer magic number (e.g., −8,302,659,996,968,415,252), “fileLength,” a 64-bit integer indicating the total number of bytes in the archived file, “lastBlock,” a 64-bit integer indicating the byte offset of the last block in the file, and “data,” with block size less 32 bytes (occupied by the header above).

The archived file content may comprise File Data Blocks. File Data Blocks may comprise fields comprising: “nextBlock,” a 64-bit integer indicating the byte offset of the next file data block in this file, or zero if there are no further file data blocks, and “data,” with a block size less 8 bytes (occupied by nextBlock).

Within the archived file content, Files are identified by IDs, which in some implementations are the byte offsets of their file header blocks. Further identification of files in the archive may be done through an external reference such as a database. File IDs can be recovered from the archive without reference to external data making use of the magic number stored in each file header block. In some implementations, additional data, such as a file name, may be stored in the file header block.

The following algorithms may be used along with any random-access archive file with conventional seek, length, read and write operations, such as the “ZIP” format, for example: an “allocate” function, to allocate a block from the free list if available or, if the free list is empty, at the end of the archive file which is extended to accommodate the new block, a “create” function, to create a new, empty archived file and return its file ID, a “delete” function, to return the storage associated with an archived file to the free list for re-use, and an “erase” function, to overwrite the content of an archived file with zeroes and return the storage it occupies to the free list (i.e., a secure version of delete).

In a preferred embodiment, the following state variables may be used for reading and writing: “byte,” an array one block in length, representing data currently being prepared for writing or reading, “length,” a 64-bit integer representing the current length of the file, “ix,” a 32-bit integer representing the index in the buffer where reading/writing will next take place, “last,” a 64-bit integer representing the byte offset of the block currently in the buffer, and “fileId,” a 64-bit integer representing the ID of the archived file being read/written.

A Persistent Heap implementation may provide an “append” function, to prepare an archived file for writing at the end of the existing content, an “open” function, to prepare an archived file for reading from the beginning, a “read” function, to read an array of bytes from an archived file into a buffer, and a “write” function, to append an array of bytes to an archived file.

A system may have multiple storage locations (e.g., archive data stores 117). In some implementations, incoming records may be stored in two different storage locations so that in the event of any one storage location being unavailable, the system still has at least one copy of every record. In other implementations, more than two different storage locations may be used. The allocation of records to storage locations may be done according to a load-balancing in order to satisfy performance or storage capacity targets, for example. In the event that a storage location becomes permanently unavailable the system can identify the records for which only one copy exists in order that they can be replicated to restore redundancy.

In order to provide redundancy, two or more systems may be created (e.g., two or more archive servers 105). One system may be regarded as the primary or production system and the other systems as the secondary or disaster recovery systems. Incoming data or records may be copied to both the primary and secondary systems. Each system may choose one of its storage locations (e.g., archive data stores 117) according to load balancing techniques, for example. If the primary system is destroyed, for example by fire or flood, the secondary system has a complete and up-to-date copy of the data and can fully replace the primary system. In addition, in the event of some lesser failure that leaves one system with a partial copy of the data, it may be necessary to establish which data or records are missing so that they can be copied from the other system to restore the full copy. Such a partial data loss may come about because of a communications failure or loss of an individual storage unit, for example.

Each record in storage (e.g., archive data stores 117) may be assigned a segment number. In some implementations, the system clock may be used to determine segment numbers. Segment numbers may group records into batches that are small enough that, if a discrepancy or error is known to lie in a particular segment, record-by-record comparison of the segment data from all locations can be performed quickly. In some implementations, segment numbers may be assigned to records by time or batch serial number. For example, records may be assigned a segment number as the records are created, or all the records in a database may be assigned segment numbers in one batch process.

Each record in storage may also have a message digest or signature associated with it. Each segment may then have a signature created from all of the message digests or signatures associated with records that are assigned to or associated with the segments. In some implementations, segment signatures are derived pairwise from record signatures using a binary operation, for example. However, other methods for creating unique segment signatures may be used. In some implementations, the signatures and binary operation may form an Abelian group. For example, integers modulo some large power of two and addition or exclusive-or meet this requirement.

The archive data stores 117 may further have an associated S-tree data structure to allow the data in the data store 117 to be reconstructed from other archive data stores 117 in the event of a data failure, for example. An S-tree is a data structure that provides the ability to update the signature of a single segment or find the combined signature of a range of segments. Other operations may also be implemented depending on the specified application. For example, the ability to delete a range of segments may be required when batches of records expire under a retention policy. The S-tree data structure allows these operations to be implemented. In some implementations, the signature binary operation used may be exclusive-or. However, other binary operations may be used.

Each storage location (e.g., archive data stores 117) may have an associated S-tree. For example, the S-tree may be stored in the archive data store 117 that it is associated with. On arrival at a storage location, each record's segment and signature are added to the S-tree. For example, when a record is added to an archive data store 117, the record is assigned to a segment and its signature is calculated. The signature and computed signature are then added to the S-tree associated with the archive data store 117.

To identify discrepancies between a primary and a secondary storage location, a modified binary search can be used. First, the combined signature for the full range of segments is obtained from each S-tree. These are further combined using exclusive-or. If there are no discrepancies then the result is zero. If there are discrepancies then the range can be divided into two and each half treated separately and the process repeated until individual segments are identified. At that point record-by-record comparison between the storage locations can be used to identify and fix the missing records. For disaster recovery, the signature operation may be addition. However, other signature operations may be used.

To identify problems, a modified binary search can be used. First, the combined signature for the full range of segments is obtained from every S-tree in the system. Those on the primary system are combined into one figure and those on the secondary system are combined into a second figure. If there is a discrepancy then the range can be divided into two and each half treated separately until individual segments are identified. At that point, record-by-record comparison between the systems can be used to identify and fix the missing records.

In contrast with a B-tree, S-tree child pointers may carry partial checksums at all levels of the tree. In the description of algorithms given below, the checksum operator is assumed to be addition, however any operator forming an Abelian group may be used. For example, addition modulo some power of 2, or bitwise exclusive-or, would be practical alternatives.

S-tree nodes may be internal nodes (Inode) or external nodes (Enode). The following functions may apply to an Inode: “parent(i),” which returns the node's parent, “keys(i),” which for a node of size n, returns a list of n−1 keys representing the sub-ranges of the child nodes, “chk(i),” which returns a list of checksums representing the combined exclusive-or of the checksums of the child notes, “child(i),” which returns the node's children, and “size(i),” which returns the number of children in the node.

The following functions apply to an Enode: “parent(i),” which returns the node's parent, “keys(i),” which returns a list keys contained in the node, “chk(i),” which returns a list of checksums for the keys in the node, and “size(i),” which returns the number of keys contained in the node.

An S-tree may comprise a root node r, and M, an integer which is the maximum size of a node. In some implementations, the structure and algorithms may allow for variable-length records.

A “rangesum” algorithm may be used to calculate the checksum of a specified range of keys in time O(log(N)) for a tree containing keys. An “insert” algorithm may be used to insert a new, unique key into the tree along with its checksum. A “split” function may be used to split an oversized node, inserting a new key in the parent if possible. Four cases exist, depending on whether the node is internal or external, and root or non-root. An “update” algorithm may be used to replace the checksum for an existing key. A “range delete” function removes a range of keys and their associated checksums from the tree. The function may also return the total checksum of the range removed.

The archive data stores 117 may include redundant data. In some implementations, each piece of data or record in a particular archive data store 117 may have a duplicate piece of data or record in another archive data store 117. Other implementations may have two or more duplicates of each piece of data in an archive data store 117. Including redundant data in the archive data stores 117 prevents data loss if one or more of the archive servers 105 fail or become temporarily unavailable, for example.

The archive servers 105 may interface with one or more data generating systems 130. The data generating systems 130 may include a variety of systems that generate and use data including, but not limited to, a document management system, a voice mail system, or an e-mail system, for example.

The data generating systems 130 may interface with the archive servers 105 using the network 115. The data generating systems 130 may store and retrieve data from the archive servers 105 (e.g., at the archive data stores 117). In some implementations, users of the data generating systems 130 may specify how the archive servers 105 store and maintain the generated data. For example, the archive servers 105 may be configured to enforce corporate policies by automatically deleting data from the archive data stores 117 older than a specified period of time. The archive servers 105 may be further configured to comply with statutory data retention and reporting guidelines (e.g., Sarbanes-Oxley, HIPPA, etc.).

In some implementations, where the data generating system 130 is an e-mail system and the data in the archive data stores 117 include e-mail data, or mailbox data, the archive servers 105 may support unified journal and mailbox management. For example, every e-mail generated by data generating systems 130 may be captured, indexed, and archived for a specified period of time in one or more of the archive servers 105. In some implementations, messages in user mail boxes of users associated with the data generating systems 130 may be replaced by shortcuts or stubs that point to the associated message in the archive servers 105, for example.

The archive servers 105 may further include synchronization modules 119. The synchronization module 119 may ensure that the redundant data stored in the archive data stores 117 of the archive servers 105 remains synchronized and that any shared resources (e.g., persistent heaps or relational databases) remain synchronized.

For example, where each of the archive servers 105 accesses a persistent heap or relational database, a local copy of the persistent heap or relational database may be stored in the archive data store 117 of each archive server 105. However, when a particular archive server 105 alters the local copy of the persistent heap or relational database (e.g., inserts, deletes, or updates a record), the change to the local copy must be conveyed to the copies at the other archive servers 105 to maintain data integrity. In order to facilitate synchronization, each record in the persistent heap or relational database may be assigned a unique global identifier and a version number. A synchronization module 119 may then determine if a record at another archive server 105 is more current, by comparing the version numbers, for example. If a record in another archive server 105 is more current than a record in the archive server 105, then the synchronization module 119 may replace the less current record with the more current record. By periodically comparing records against records stored by other archive servers 105, the local copies of the persistent heap or relational database may be kept synchronized with respect to one another, for example.

The agent modules 116 may each implement a variety of services. In some implementations, the agent modules 116 may provide a directory service. The directory service may maintain information on individual users (e.g., users of an e-mail or document management system implemented by the data generating system 130). The information may further include the various folders or directories and subdirectories associated with each user, as well as the folders or directories and subdirectories that each user has access to (e.g., permissions).

In some implementations, the agent modules 116 may provide a storage service. For example, the storage service may maintain the various records and files stored in the archive data store 117. The storage service may be responsible for adding new records and files to the archive data store 117, as well as retrieving particular records and files from the archive data store 117.

In some implementations, the agent modules 116 may include a search service. The search service may allow users to search the various files, records and documents available on the various archive data stores 117, for example.

The environment 100 may further include one or more satellite systems 106. The satellite systems 106 may connect to one or more of the archive servers 105 through the network 115, for example. The satellite data systems 106 may be implemented by a laptop or other personal computer. A user associated with a satellite system 106 may use resources provided by the agent modules 116 of the archive servers 105. For example, a user of the satellite system 106 may use an e-mail or document management system provided by the data generating system 130. The user may search for and use documents or e-mails stored on the various archive servers 105 through the satellite system 106.

The satellite system 106 may include a satellite data store 121. The satellite data store 121 may be implemented similarly as the archive data store 117 described above. Because the satellite system 106 may be periodically disconnected from the network 115 and therefore unable to access the various archive servers 105, the satellite data store 121 may include all or some subset of the files or records stored at the archive data stores 117 of the archive servers 105. In some implementations, the satellite data store 121 may have all of the records from the archive data stores 117 that the user associated with the satellite system 106 has access to. For example, where the satellite system 106 provides access to a mailbox associated with an e-mail account, the satellite data store 121 may include the various files or records from the archive data stores 117 associated with the user's mailbox.

The satellite system 106 may further include one or more satellite agent modules 120. The satellite agent modules 120 may provide the same services as the agent modules 116 described above. For example, the satellite agent modules 120 may provide search, directory, and storage services to the user associated with the satellite system 106. The satellite agent modules 120 may be substantially similar to the agent modules 116 except the satellite agent modules 120 may not be discoverable by agent modules 116 on the network 115 (i.e., the satellite agent modules 120 may only provide services to the user associated with the particular satellite system 106 where the agent module is implemented).

The satellite system 106 may use the services associated with satellite agent modules 120 when disconnected from the network 115, and may use the services associated with agent modules 116 when connected to the network 115. For example, when the user associated with the satellite system 106 is traveling, or otherwise unable to connect to one of the archive servers 105 to view e-mail or other documents associated with the user, a local satellite agent module 120 may provide the user with the desired service using the data locally stored in the satellite data store 121, for example. The transition between the agent modules 105 and the satellite agent modules 120 is desirably implemented such that the user associated with the satellite system 106 is unaware of the transition, or sees no degradation in performance, for example.

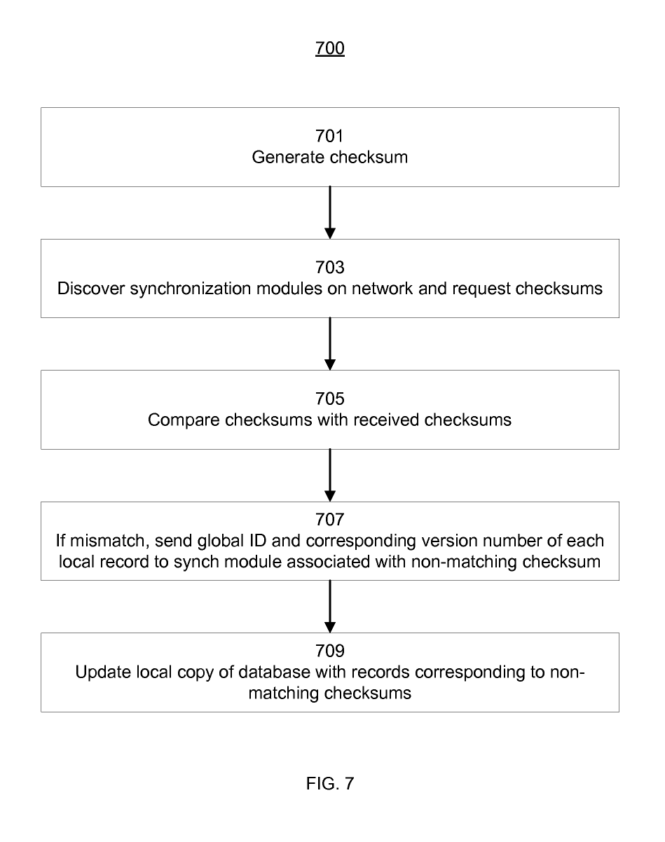

The satellite system 106 may further include a satellite synchronization module 122. The synchronization module 122 may ensure that the data in the satellite data store 121 is synchronized with the data in the archive servers 105 when the satellite system 106 returns to the network 115. For example, while disconnected from the network 115, the user of the satellite system 106 may make several changes to one or more documents, records, or files stored in the local satellite data store 121. Similarly, users may make changes to one or more of the corresponding documents, records, or files in the archive data stores 117. Accordingly, when the satellite system 106 reconnects to the network 115, the documents, records, or files may be synchronized with the copies stored at the archive servers 105, for example. The files or documents may be synchronized according to the methods described in FIG. 7, for example. However, any system method or technique known in the art for synchronization may be used.

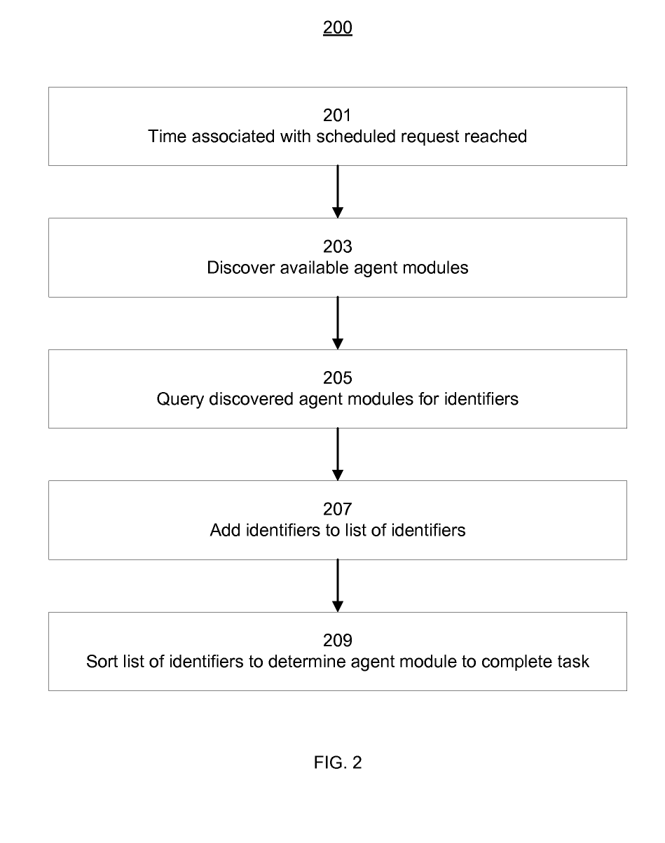

FIG. 2 is an illustration of a process 200 for providing symmetric task allocation. The process 200 may be implemented by one or more agent modules 116 of the archive servers 105, for example.

A time associated with a scheduled request is reached (201). One or more agent modules 116 may determine that a time associated with a scheduled request has been reached. For example, in one implementation, one or more of the agent modules 116 may have a queue or list of scheduled tasks and associated execution times. The request may comprise a variety of requests including a batch job, for example. Scheduled tasks include synchronization of redundant data, synchronization of relation databases, polling a data source, processing management reporting data, expiring old records, compiling system health summaries, for example. In some implementations, each agent module 116 may have a copy of the schedule of tasks for each agent 117, for example.

Available agent modules 116 are discovered (203). One or more of the agent modules 116 may discover other available agent modules 116 on the network 115, for example. In some implementations, the agent modules 116 may discover other agent modules using a service such as JXTA, for example.

Discovered agent modules 116 are queried to respond with an identifier associated with each agent module 116 (205). In some implementations, each agent module 116 may have an associated identifier. The associated identifier may be generated by the agent modules 116 randomly using a cryptographically secure random number generating technique, for example. The random number generated is desirably large enough to ensure that no two agent modules 116 generate the same identifier. For example, the identifier may be 80-bits long.

The received agent module 116 identifiers, as well as the identifier of the receiving agent module 116, are added to a list of available agent modules 116 (207). For example, each agent module 116 may maintain a list of the various agent modules 116 available on the network 117, for example.

The list of available agent modules 116 is sorted to determine which of the available agent modules 116 should perform the scheduled task (209). For example, the identifiers may be sorted from highest to lowest, with the agent module 116 having the highest identifier responsible for executing the scheduled task. Alternatively, the identifiers may be sorted from lowest to highest, with agent module 116 with the lowest identifier responsible for executing the scheduled task.

If a particular agent module 116 determines that it should complete the task, then the agent module 116 may begin executing the scheduled task. Otherwise, the agent module 116 assumes that the responsible agent module 116 will complete the task.

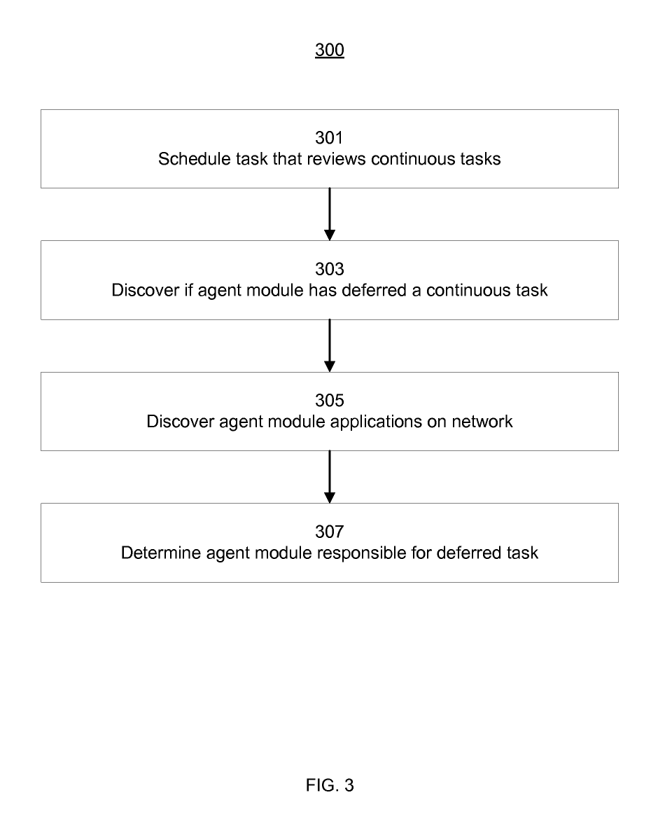

FIG. 3 is an illustration of a process 300 for providing symmetric task allocation for continuous tasks. The process 300 may be implemented at one or more agent modules 116 of the archive servers 105, for example. Continuous tasks may include polling a data source such an Exchange server, for example.

Each agent module 116 may schedule a task that reviews the continuous tasks allocated to the various agent modules 116 (301). For example, each agent module 116 may contain a list of the various continuous tasks that must be performed by the various agent modules 116 on the network 115 and a maximum amount of time that the task may be deferred by an agent module 116. The scheduled task may cause the agent module 116 to contact one or more of the agent modules 116 scheduled to be performing a particular continuous task to determine if the task has been deferred or otherwise not yet performed, for example.

An agent module 116 discovers that another agent module 116 has deferred a scheduled continuous task for more than the maximum amount of time (303). In some implementations, the agent module 116 may assume that another agent module 116 has deferred a task if the agent module 116 is unresponsive. For example, the archive server 105 associated with the agent module 116 may have crashed or become non-responsive and is therefore unable to perform the task. Accordingly, the agent module 116 that discovered the deferred task may begin executing or performing the deferred task.

The agent module 116 discovers available agent modules 116 on the network 115 (305). The agent module 116 may further request identifiers from all of the discovered agent modules 116.

The agent module 116 determines which of the discovered agent modules 116 (including itself) is responsible for performing the deferred task (307). In some implementations, the agent module 116 may sort the agent identifiers and select the highest agent identifier as the agent module 116 responsible for performing the deferred task. However, a variety of techniques and methods may used to determine the responsible agent module 116 from the agent identifiers.

If the agent module 116 determines that it is the responsible agent module 116 for the deferred task, then the agent module 116 may continue to execute the deferred task. Otherwise, the agent module 116 may halt execution of the deferred task and another agent module 116 will determine that the task has been deferred when it reviews the status of the continuous tasks, for example. In some implementations, the agent module 116 may send the responsible agent module 116 a message informing it that it is the responsible agent module 116.

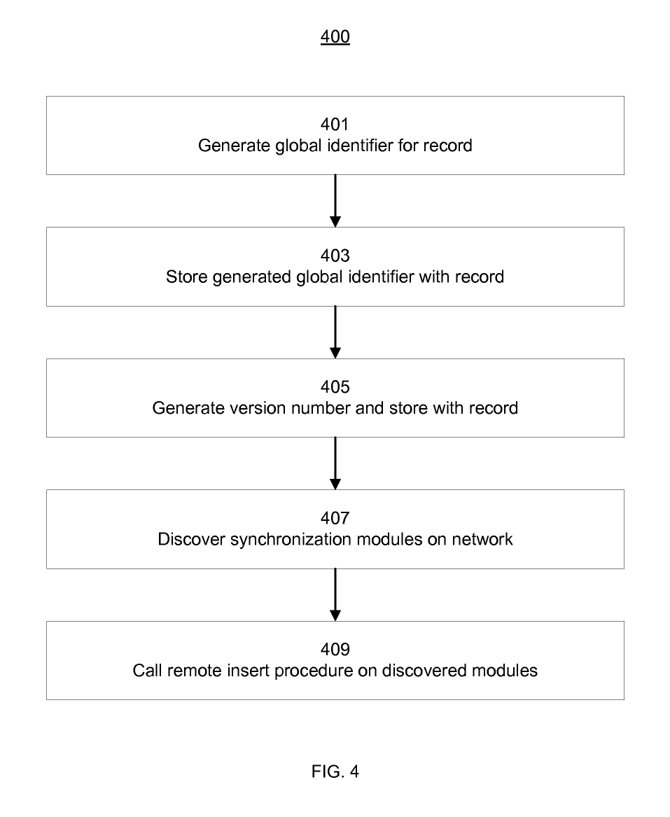

FIG. 4 is an illustration of a process 400 for inserting a record into a local copy of a shared persistent heap or relational database. The process 400 may be executed by a synchronization module 119 and an agent module 116 of an archive server 105, for example.

An agent module 116 may wish to insert a record into a copy of a persistent heap or relational database stored in the archive data store 117. For example, the agent module 116 may be implementing a storage service on an archive server 105. Accordingly, a new global identifier is generated for the new record (401). The record may be inserted into the local copy of the persistent heap or relational database with the generated global identifier (403). Further, a version number may be stored with the inserted record (405). In some implementations, the version number is set to ‘1’ to indicate that the record is a new record, for example.

After inserting the record into the local copy of the persistent heap or relational database, the synchronization module 119 discovers the synchronization modules of the other archive servers 105 on the network 115 (407). In some implementations, after inserting the record into the local copy of the persistent heap or relational database the agent module 116 implementing the storage service may prompt the synchronization module 119 to discover the other synchronization modules on the network 115, for example.

The synchronization module 119 may call a remote insert procedure on each of the discovered synchronization modules 119 (409). In some implementations, the remote insert procedure causes the discovered synchronization modules 119 to insert the new record into their local copy of the persistent heap or relational database. The records may be inserted using the generated global identifier and version number, for example. In some implementations, the synchronization modules 119 may instruct an agent module 116 implementing a storage service to insert the insert the new record into their local copy of the persistent heap or relational database, for example.

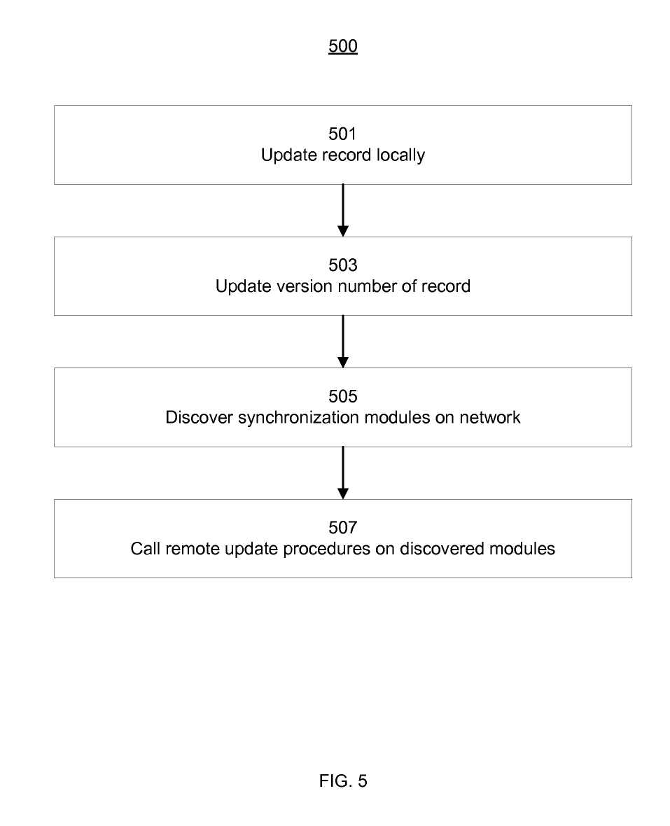

FIG. 5 is an illustration of a process 500 for updating a record in a local copy of a shared persistent heap or relational database. The process 500 may be implemented by an agent module 116 and a synchronization module 119 of an archive server 105, for example.

An agent module 116 may wish to update a record into a copy of a persistent heap or relational database stored in the archive data store 117. For example, the agent module 116 may be implementing a storage service on an archive server 105. Accordingly, the record is located in the local copy of the relational database and updated to reflect the modified record (501). The version number of the record may also be updated to reflect that the record is a new version (503). In some implementations, the version number is incremented by ‘1’, for example.

The synchronization module 119 discovers the synchronization modules of the other archive servers 105 on the network 115 (505). In some implementations, after updating the record in the local copy of the persistent heap or relational database, the agent module 116 implementing the storage service may prompt the synchronization module 119 to discover the other synchronization modules on the network 115, for example.

The synchronization module 119 may call a remote update procedure on each of the discovered synchronization modules 119 (509). In some implementations, the remote insert procedure causes the discovered synchronization modules 119 to update the record in their local copy of the persistent heap or relational database. Further, the global identifier associated with the record may be incremented. In some implementations, the synchronization modules 119 may instruct an agent module 116 implementing a storage service to update the record in their local copy of the persistent heap or relational database, for example.

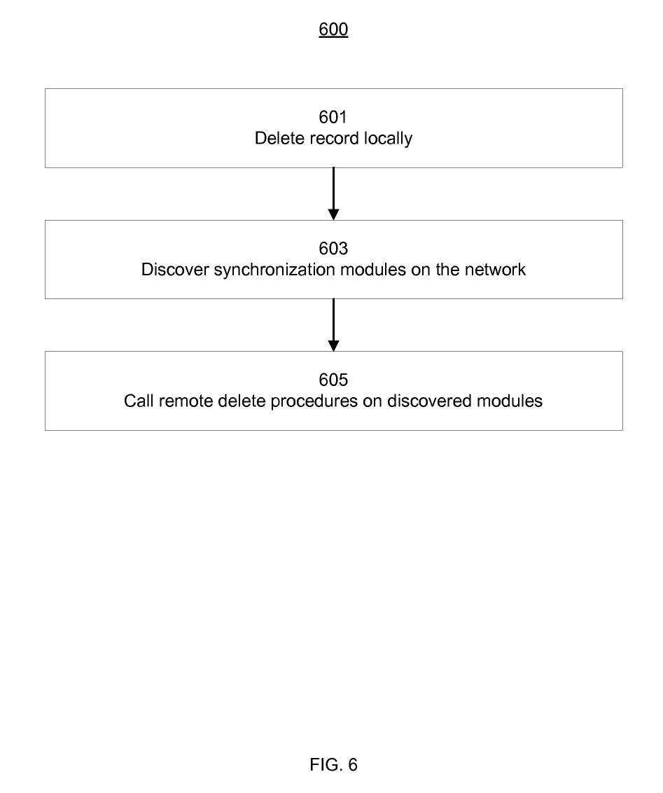

FIG. 6 is an illustration of a process 600 for deleting a record in a local copy of a shared persistent heap or relational database. The process 600 may be executed by an agent module 116 and a synchronization module 119 of an archive server 105, for example.

An agent module 116 may wish to delete a record from a local copy of a persistent heap or relational database stored in the archive data store 117. For example, the agent module 116 may be implementing a storage service on an archive server 105. Accordingly, the record is located in the local copy of the persistent heap or relational database and deleted from the database (601). In some implementations, the record is removed from the database. In other implementations, the record is altered or otherwise modified to indicate that it has been deleted and is not a valid record. For example, the version number associated with the record may be set to a value reserved for deleted records (e.g., a maximum value supported by the field).

The synchronization module 119 discovers the synchronization modules of the other archive servers 105 on the network 115 (603). In some implementations, after deleting the record from the local copy of the persistent heap or relational database, the agent module 116 implementing the storage service may prompt the synchronization module 119 to discover the other synchronization modules on the network 115, for example.

The synchronization module 119 may call a remote delete procedure on each of the discovered synchronization modules 119 (605). In some implementations, the remote delete procedure causes the discovered synchronization modules 119 to delete the record in their local copy of the persistent heap or relational database. In other implementations, the record may be altered to indicate that it is deleted, for example, by setting the associated version number to a reserved value.

FIG. 7 is an illustration of a process 700 for synchronizing copies of persistent heaps or relational databases. The process 700 may be implemented by a synchronization module 119 of an archive server 105, for example.

An archive server 105 may desire to synchronize the records stored in their local copies of a persistent heap or relational database, for example. The frequency with which the archive servers 105 synchronize the contents of their local databases depends on a variety of factors including, but not limited to, the needs of an application associated with the database (e.g., a banking application may require a higher degree of synchronization than a document management system) and the number of archive servers 105 that have recently gone offline or that have newly joined the network 115, for example.

A digest algorithm is used to summarize the identifiers and version numbers of all the records stored in the local copy of the persistent heap or relational database on the archive server 105 and generate a checksum (701). The checksum may be generated by the synchronization module 119, for example. In some implementations, the algorithm is the SHA-1 algorithm. However, a variety of methods and techniques may be used.

The synchronization module 119 discovers the other synchronization modules 119 of the archive servers 105 on the network 115 and requests the checksums of their corresponding local copy of the persistent heap or relational database (703).

The synchronization module compares the received checksums from each of the received synchronization modules 119 (705). If one of the received checksums fails to match the local checksum, then the synchronization module may send the global identifier and corresponding version number of each record in the local persistent heap or relational database to the synchronization module 119 associated with the non matching check checksum (707). The synchronization module 119 receives the identifiers and version numbers and responds by providing any missing records or records that have version numbers that are higher than the provided version numbers for the same global identifiers. The synchronization module 119 at the archive server 105 that originated the synchronization request receives the records, and updates the copy of the local persistent heap or relational database using the received records (709).

FIG. 8 is a block diagram of an example computer system 800 that can be utilized to implement the systems and methods described herein. For example, all of the archive servers 105 and satellite systems 106 may be implemented using the system 800.

The system 800 includes a processor 810, a memory 820, a storage device 830, and an input/output device 840. Each of the components 810, 820, 830, and 840 can, for example, be interconnected using a system bus 850. The processor 810 is capable of processing instructions for execution within the system 800. In one implementation, the processor 710 is a single-threaded processor. In another implementation, the processor 710 is a multi-threaded processor. The processor 810 is capable of processing instructions stored in the memory 820 or on the storage device 830.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 can, for example, include a hard disk device, an optical disk device, or some other large capacity storage device.

The input/output device 840 provides input/output operations for the system 800. In one implementation, the input/output device 840 can include one or more of a network interface devices, e.g., an Ethernet card, a serial communication device, e.g., and RS-232 port, and/or a wireless interface device (e.g., and 802.11 card). In another implementation, the input/output device can include driver devices configured to receive input data and send output data to other input/output devices, e.g., keyboard, printer and display devices 860.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

I claim:

1. A method for archive of data by an archive server comprising the steps of:
receiving a data record over a network from a data generating system;
assigning the data record to a storage segment;
calculating a signature for data comprising the received data record;
storing the calculated signature and an indication of the assigned storage segment in a data structure associated with an archive data store; and
storing data comprising the received data record in the archive data store.

2. The method of claim 1 wherein the data generating system comprises at least one of an email server, a voicemail server, or a document management server.

3. The method of claim 1 wherein the data structure associated with the archive data store comprises an S-tree.

4. The method of claim 1 wherein the archive data store comprises a persistent heap.

5. The method of claim 1 wherein the archive data store comprises a relational database.

6. The method of claim 1, further comprising the step of encrypting data comprising the data record.

7. The method of claim 1, further comprising the step of compressing data comprising the data record.

8. The method of claim 1 wherein the signature comprises a checksum.

9. The method of claim 1, further comprising the steps of, responsive to a determination that a specified period of time has passed, automatically deleting the stored data comprising the received data record and removing the calculated signature and the indication of the assigned data segment from the data structure associated with the archive data store.

10. A system for the archiving and retrieval of data comprising:
a processor operative to process instructions related to agent module software;
a storage device for storing data of an archive data store; and
a network interface;
wherein processing of instructions related to agent module software comprises steps of:
receiving a data record over a network from a data generating system;
assigning the data record to a storage segment;
calculating a signature for data comprising the received data record;
storing the calculated signature and an indication of the assigned data segment in a data structure associated with an archive data store; and
storing data comprising the received data record in the archive data store.

11. The system of claim 10 wherein the storage device comprises at least one of a hard drive, a non-volatile memory, or a memory.

12. The system of claim 10 wherein the data generating system comprises at least one of an email server, a voicemail server, or a document management server.

13. The system of claim 10 wherein the data structure associated with the archive data store is an S-tree.

14. The system of claim 10 wherein the archive data store comprises a persistent heap.

15. The system of claim 10 wherein the archive data store comprises a relational database.

16. The system of claim 10, wherein processing of the instructions related to agent module software further comprises the step of encrypting data comprising the data record.

17. The system of claim 10, wherein processing of the instructions related to agent module software further comprises the step of compressing data comprising the data record.

18. The system of claim 10 wherein the signature comprises a checksum.

19. The system of claim 10, wherein processing of the instructions related to agent module software further comprises the step of, responsive to a determination that a specified period of time has passed, automatically deleting the stored data comprising the received data record and removing the calculated signature and the indication of the assigned data segment from the data structure associated with the archive data store.

20. A system for the archive of data by an archive server comprising:
means for receiving a data record over a network from a data generating system;
means for assigning the data record to a storage segment;
means for calculating a signature for data comprising the received data record;
means for storing the calculated signature and an indication of the assigned storage segment in a data structure associated with an archive data store; and
means for storing data comprising the received data record in the archive data store.

21. The system of claim 20 wherein the data generating system comprises at least one of an email server, a voicemail server, or a document management server.

22. The system of claim 20 wherein the data structure associated with the archive data store comprises an S-tree.

23. The system of claim 20 wherein the archive data store comprises a persistent heap.

24. The system of claim 20 wherein the archive data store comprises a relational database.

25. The system of claim 20, further comprising means for encrypting data comprising the data record.

26. The system of claim 20, further comprising means for compressing data comprising the data record.

27. The system of claim 20 wherein the signature comprises a checksum.

28. The system of claim 20, further comprising means for, responsive to a determination that a specified period of time has passed, automatically deleting the stored data comprising the received data record, and means for removing the calculated signature and the indication of the assigned data segment from the data structure associated with the archive data store.
